(19) United States
(12) Patent Application Publication
(10) Pub. No.: US 2022/0403282 A1
(43) Pub. Date: Dec. 22, 2022

(54) INTERNAL LUBRICANT COMPOSITION AND USE

(71) Applicant: Croda International Plc, Goole, East Yorkshire (GB)

(72) Inventors: Adam John Maltby, Goole, East Yorkshire (GB); Dimitrios Vgenopoulos, Goole, East Yorkshire (GB)

(73) Assignee: Croda International Plc, Goole, East Yorkshire (GB)

(21) Appl. No.: 17/763,955

(22) PCT Filed: Oct. 2, 2020
(86) PCT No.: PCT/EP2020/077625

§ 371 Date: Mar. 25, 2022

(30) Foreign Application Priority Data
Oct. 4, 2019 (GB) 1914337.9

(51) Int. Cl. C10M 129/68; C10M 129/95

(52) U.S. Cl. CPC C10M 129/68; C10M 129/95

(57) ABSTRACT

The present invention relates to an internal lubricant composition comprising two or more esters in which each individual ester has a carbon chain length of between 20 and 44. The internal lubricant composition may suitably be incorporated in to a polyester polymer matrix, preferably comprising PET, PETg or PLA. Use of the internal lubricant composition in a polyester polymer matrix to improve processes for manufacture of final products from the polyester polymer matrix is also contemplated.

The present invention relates to an internal lubricant composition. The internal lubricant composition may suitably be incorporated into a polyester polymer matrix. Use of the internal lubricant composition in the polyester polymer matrix to improve manufacturing processes for final products utilising the polyester polymer matrix is also provided.

A polyester polymer matrix is typically formed from a polyester homopolymer or copolymer with the inclusion of other polymer additives dependent upon the desired use of the final polyester product to be formed from the polyester polymer matrix. In polyester product manufacturing processes heat, or heat and pressure, are commonly utilised to allow a prepared polyester polymer matrix to stretch or flow into a final product form or shape. The polyester polymer matrix may be provided to such a polyester final product manufacturing process in a solid state. Alternatively, a polyester polymer matrix may be prepared and whilst still in a fluid state be subject to a subsequent final product manufacturing step to render the polymer matrix in its final useful form or shape. It is most common for the polymer matrix to be manufactured and solidified, so that it is in a form suitable for shipping to an alternative site for final manufacture into a desirable end product. Methods for providing a polyester polymer matrix as solid granules, pellets, chips, rods and sheets are known in the art.

Polyethylene terephthalate (PET) is an important polyester polymer material, widely used in the manufacture of films, moulded and biaxially oriented polyester products. The most common application for PET homopolymer and copolymers is in the manufacture of bottles, although many other uses are known.

PET bottles are produced predominantly using a two stage stretch blow moulding process. Firstly, a preform is produced by injection moulding. This is a relatively thick walled component with the final bottle neck features moulded during this process. Secondly, the preform is reheated in a reheat blow machine which stretches the preform by a stretching pin and inflates it by blowing air into the mould to give the desired bottle shape. This gives a biaxially orientated container which provides improved properties such as clarity and gas barrier performance in the final bottle, as well as mechanical improvements.

PET bottles may also be manufactured by injection blow moulding which is a 2-stage technique performed on a single machine. The preform is injection moulded and whilst still hot is moved to a blowing station where it is blown up to the desired bottle shape. This is the preferred technique for small containers requiring specific neck detail or finish and produces containers that are less biaxially orientated.

When PET is used to manufacture other (i.e. non-bottle) products alternative methods of manufacture may also be utilised besides those mentioned above, in particular including methods of thermoforming where a polymer matrix sheet is heated, shaped in or against a mould and trimmed to provide the desired final product shape. Formation of films and fibres can also be achieved by stretching of the polymer matrix in a biaxial or monoaxial direction, respectively. In particular, biaxially-orientated polyethylene terephthalate (BOPET) is popular for the manufacture of films due to its high tensile strength and product stability.

PETg (polyethylene terephthalate glycol) is also an increasingly popular subset of PET based materials formed from the co-polymerisation of PET and ethylene glycol. It is considered to provide a desirable “water clear” finish to final products, with good impact resistance and chemical resistance. It finds utility in food contact products, and medical and electronic devices. It has a relatively low forming temperature.

Polylactic acid (PLA) is a polyester which is growing in popularity as an alternative to PET. A PLA based polyester polymer matrix may be further processed to provide final desirable products in the same manufacturing processes as PET based materials.

External lubricants for use in polyester products are known in the art and are commonly referred to as slip additives. Slip additives advantageously migrate to a polyester product surface to allow the final product to have a reduced coefficient of friction relative to an opposing alternative product surface. However, when processing a polyester polymer matrix to render it in its final desirable product form or shape sufficient heat (at a temperature T above the materials glass transition temperature, T_{g}) and/or pressure or mechanical stress must be utilised to overcome the internal friction experienced between polymer chains making up the polymer matrix, thus allowing the polymer matrix to deform in a controlled manner which is conducive to the formation of the final product. Internal and external friction are not equivalent phenomena and as such external lubricants (slip additives) and internal lubricants are distinct technologies, as will be understood by the skilled person. In particular, internal lubricants will advantageously not migrate to the polyester surface, as lubrication of the bulk polymer matrix is essential to achieve good internal lubrication properties. More especially, internal lubricants are concerned with reduction of internal friction in a polymer matrix melt and are associated with a reduction in heat build-up in the polymer matrix when subject to mechanical stress during final product manufacturing processes.

An important requirement of internal lubricants is that they do not adversely affect the physical properties of the polyester polymer at ambient temperature; often materials which are capable of improving internal lubrication of a polyester polymer matrix result in an unacceptably soft final polyester product.

Furthermore, those skilled in the art will be aware that separate and different classes of polymers have widely different chemical compositions and different molecular architectures. Thus, polyester polymers such as PET, PETg and PLA cannot be compared with polyvinyl chloride (PVC), polyamides such as nylon, or other classes of polymer. The skilled person cannot extrapolate or predict how a particular compound, or mixture of compounds, will perform as an internal lubricant based on its performance in a different class of polymers.

The present invention is concerned with providing an internal lubricant composition for reducing the internal friction of a polyester polymer matrix. This will allow for polyester final product processing benefits, more especially permitting use of lower final product processing temperatures and additionally or alternatively permitting a further degree of product stretching at a given processing temperature, which will have associated energy and cost savings.

### SUMMARY OF THE INVENTION

In accordance with a first embodiment of the present invention there is provided an internal lubricant composition suitable for use in a polyester polymer matrix composition comprising a mixture of two or more esters in which each individual ester has a carbon chain length of between 20 and 44.

According to an alternative embodiment of the present invention there is provided a polyester polymer matrix comprising said internal lubricant composition.

According to a further embodiment of the present invention there is provided use of said internal lubricant composition in a polyester polymer matrix to improve post processing of the polymer matrix to form a final polyester product.

The term “%” as used herein relates to weight % (wt %) of the overall composition being described.

The term “PET” as used herein in describing some embodiments of the present invention should be understood to have a broad meaning. It includes all polymeric and copolymeric forms of polyethylene terephthalate. Thus, the term PET should be considered, in this context, to be a generic term to include all polymers derived from aromatic diacids including all terephthalate polymers and their derivatives, both known and those yet to be discovered.

The term polyester also has a broad meaning in this context. It includes polymers containing a number of ester linkages in the main chain. This includes, but is not limited to, polymers produced by reacting dibasic acids with dihydric alcohols, by reacting polyhydroxyl compounds with a carbonic acid derivative (polycarbonates) and polymers derived by ring opening polymerization of lactide to polylactide.

The internal lubricant composition suitable for use in a polyester polymer matrix composition comprises a mixture of two or more esters in which each individual ester has a carbon chain length of between 20 and 44. Preferably said composition is formed by reacting one or more carboxylic acids each having a carbon chain length between 1 and 22, with one or more alcohols each having a carbon chain length between 1 and 22. In an alternative embodiment, said composition may be formed by mixing together two or more esters, each individual ester having a carbon chain length between 20 and 44.

More especially, said internal lubricant composition comprises at least two esters of general Formula I,

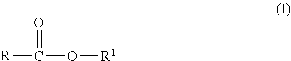

wherein: R and R¹ represent hydrocarbon moieties, each hydrocarbon moiety comprising 1 to 22 carbon atoms and wherein R and/or R¹ may be linear, branched chain, saturated or contain one or more double bonds;

and wherein the total number of carbon atoms in each individual ester in the mixture is between 20 and 44.

Preferably the two or more esters of general Formula I comprise at least 95% of the composition. Suitably, the composition may consist essentially of the two or more esters according to general Formula I.

Preferably the esters of general Formula I are formed by reacting one or more carboxylic acids having a general Formula RCO₂H (II) with one or more alcohols having a general Formula R¹OH (III), such that the total number of carbon atoms in each individual ester in the mixture is between 20 and 44.

In an alternative embodiment said composition is formed by mixing together two or more esters of general Formula I, each individual ester having a total number of carbon atoms between 20 and 44.

Preferably the total number of carbon atoms in each individual ester in the mixture is between 24 and 40, and more preferably between 28 and 34.

Preferably each individual ester in the mixture is an aliphatic ester.

Optionally, the internal lubricant composition may be formed by mixing (or blending) together two or more esters, as described above. This mixing (or blending) of preproduced esters allows for more control over the ester mixture, and this results in a more predictable internal lubricant composition, with associated process control when in use.

Suitably, the internal lubricant composition comprises two or more esters selected from the group comprising:—

myrisityl myristate

myrisityl palmitate

palmityl myristate

palmityl palmitate

palmityl stearate

stearyl myristate

stearyl palmitate

stearyl stearate

stearyl arachidate and

stearyl behenate.

Preferably the internal lubricant composition comprises two or more esters selected from the group comprising:—

myristyl myristate

myristyl palmitate

palmityl myristate

palmityl palmitate

stearyl myristate and

stearyl palmitate.

Preferably said composition comprises three or more esters selected from said group. More preferably said composition comprises between four and twelve esters selected from said group, most preferably said composition comprises between four and ten esters selected from said group.

Preferably each individual ester component may be present in an amount of 0.5% to 95%, more preferably 1% to 85%, even more preferably 3% to 75%, and most preferably 5% to 65% by weight of the total internal lubricant composition. It is particularly preferred that each individual ester component may be present in an amount of 0.5% to 45%, more preferably 1% to 45%, even more preferably 3% to 45%, and most preferably 5% to 45% by weight of the total internal lubricant composition.

Preferably said composition comprises <1% to 17% myristyl myristate, 0.5% to 38% myristyl palmitate, 4% to 45% palmityl myristate, 4% to 45% palmityl palmitate, 2% to 20% stearyl myristate, 4% to 45% stearyl palmitate, <1% to 4% palmityl stearate, <1% to 4% stearyl stearate, <1% to 3% stearyl arachidate, and <1% to 4% stearyl behenate, by weight.

Preferably the composition comprises 10% to 17% myristyl myristate, 2% to 28% myristyl palmitate, 15% to 42% palmityl myristate, 8% to 42% palmityl palmitate, 4% to 18% stearyl myristate and 6% to 12% stearyl palmitate, by weight.

Preferably the composition comprises 12% to 16% myristyl myristate, 6 to 10% myristyl palmitate, 30% to 40% palmityl myristate, 18% to 22% palmityl palmitate, 12% to 14% stearyl myristate and 7% to 10% stearyl palmitate, by weight.

Preferably the composition comprises 7% to 9% myristyl myristate, 16% to 19% myristyl palmitate, 4% to 6% palmityl myristate, 10% to 12% palmityl palmitate, 2% to 4% stearyl myristate and 5% to 7% stearyl palmitate and 40% to 45% stearyl stearate, by weight.

Preferably the composition comprises 7% to 9% myristyl myristate, 16% to 19% myristyl palmitate, 4% to 6% palmityl myristate, 10% to 12% palmityl palmitate, 2% to 4% stearyl myristate, 4% to 6% stearyl palmitate, <1% to 2% stearyl stearate, 1% to 3% stearyl arachidate and 40% to 45% stearyl behenate.

Preferably the composition comprises 7% to 9% myristyl myristate, 16% to 19% myristyl palmitate, 4% to 6% palmityl myristate, 10% to 12% palmityl palmitate, 2% to 4% stearyl myristate and 48% to 53% stearyl palmitate, by weight.

In accordance with an alternative embodiment of the present invention there is provided a polyester polymer matrix comprising a polyester polymer and an internal lubricant composition as described above.

Suitably, the polyester polymer may comprise a homopolymer or copolymer.

Preferably the polyester polymer is selected from the group comprising:—

poly(butylene terephthalate)

poly(cyclohexanedimethylene terephthalate)

poly(ethylene isophthalate)

poly(ethylene 2,6-naphthalenedicarboxylate)

poly(ethylene phthalate)

poly(ethylene terephthalate)

PETg (polyethylene terephthalate glycol)

polycarbonates

polylactic acid (PLA)

polyhydroxyalkanoates (PHA)

and co-polymers thereof.

More preferably, the polyester polymer comprises poly(ethylene terephthalate). This polymer is particularly preferred for making bottles. Additionally, or alternatively, the poly(ethylene terephalate) may preferably be biaxially-orientated polyethylene terephthalate (BOPET). This polymer is particularly preferred for making films.

Additionally, or alternatively, the polyester polymer preferably comprises polylactic acid (PLA). The polylactic acid may comprise poly-L-lactic acid (PLLA). The polylactic acid may comprise poly-D-lactic acid (PDLA). Preferably the polylactic acid comprises at least 70 wt % PLLA. Such a polyester polymer may provide desirable biodegradability properties in any final polyester product produced.

Preferably said polymer matrix composition comprises said internal lubricant composition in an amount of between 0.05 wt % to 1.0 wt %, more preferably in an amount of between 0.1 wt % to 0.75 wt %. The exact concentration of internal lubricant present in the polyester polymer matrix will depend upon the polyester polymer selected and the desired processing effect to be achieved in the final product manufacturing process, for example a greater amount may be provided where lower temperature thermoforming processes are to be employed versus higher temperature blow moulding processes.

Suitably, said polymer matrix may further comprise one or more additional polymer additives. Such additives are known to the skilled person and may be selected from antioxidants, IR absorbers, flame retardants, colours (dyes or pigments), carriers/dispersants for colours, other additional internal or external lubricants (e.g. pentaerythritol tetrastearate, primary, secondary or bisamides) and plasticisers, amongst others.

According to a further embodiment of the present invention there is provided use of an internal lubricant composition (as described above) in a polyester polymer matrix (as described above) in a process to produce a final polyester product.

Advantageously, use of the internal lubricant of the present invention allows processing of the polyester polymer matrix to be carried out at a lower process temperature and/or pressure and/or mechanical stress, than would be possible in the absence of the internal lubricant. Preferably, the use of the internal lubricant allows processing of the polyester polymer matrix to be carried out at a lower process temperature. The reduction in process temperature and pressure parameters has cost and safety benefits. Additionally, reductions in processing temperatures more especially can have highly beneficial energy and associated cost reductions; even a slight reduction in process operating temperature can be highly commercially beneficial.

Furthermore, use of the internal lubricant of the present invention does not have any adverse effect on the physical or chemical properties of the final polyester product formed. More especially, the rigidity and hardness of the final polyester product obtained is not compromised.

In addition, use of the internal lubricant of the present invention does not adversely affect PET clarity or gas barrier properties. More especially, use of the internal lubricant of the present invention does not adversely affect the taste or food safety of any consumable product to be stored in (or in contact with) the final polyester product.

Suitably, the internal lubricant may be used in any of the following processes:—

thermoforming

injection moulding

extrusion

cast film extrusion

blown film extrusion

extrusion blow moulding

Injection stretch blow moulding

stretch blow moulding

biaxial film orientation.

Preferably, the final polyester product produced is a container, for example product packaging and in particular a bottle. Most preferably the final polyester product produced is a bottle, and even more preferably the final polyester product is a PET bottle. The stretch blow moulding processes typically employed to produce PET bottles from preform components subject the preform components to biaxial stress to provide the final bottle shape. The preform components react to the stress in each axial direction differently, and it has advantageously been found that the internal lubricants of the present invention aid internal lubricancy of the polyester matrix in both the x and y axis of the biaxial stress applied.

Alternatively, the final polyester product is a film, for example product packaging, and in particular a food contact film. Most preferably, in this case, the final polyester product is a biaxially-orientated polyethylene terephthalate (BOPET) film. The internal lubricants of the present invention aid internal lubricancy of the polyester matrix in both the x and y axis of the biaxial stress applied to such BOPET materials.

Another option is also extruded polyester sheets (e.g. made of PETg) which are then thermoformed (i.e. oriented) to form food packaging trays and other rigid packaging products. The internal lubricants of the present invention may aid internal lubricancy of the polyester matrix when subjected to stress during the orientation process of thermoforming.

Suitable internal lubricant compositions in accordance with preferred embodiments of the present invention comprising mixed aliphatic esters are shown in Table 2 below. Of these compositions, Formulation 2 is preferred. The composition of Formulation 2 is set out in more detail in Table 1 below:—

TABLE 1
Composition of Formulation 2

| Ester | Carbon chain lengths | % wt |
|---|---|---|
| Myristyl myristate | (C14:C14) | 13.3 |
| Cetyl myristate | (C16:C14) | 33.6 |
| Stearyl myristate | (C18:C14) | 13.9 |
| Myristyl palmitate | (C14:C16) | 8.0 |
| Cetyl palmitate | (C16:C16) | 20.3 |
| Stearyl palmitate | (C18:C16) | 8.4 |
| | | 97.5 |

The other minor components (mostly mixed esters of C12-C20 fatty acids and C12-C20 fatty alcohols) will be individually present at <1%, to make up the total weight of the composition.

TABLE 2

| | | | | alcohol | | |
|---|---|---|---|---|---|---|
| Formulation 1 | | lauryl | myristyl | palmityl | stearyl | arachidyl |
| | laurate | <1 | <1 | <1 | <1 | <1 |
| acid | myristate | <1 | 14-17 | 8-12 | 4-6 | <1 |
| | palmitate | <1 | 32-38 | 20-24 | 8-12 | <1 |
| | stearate | <1 | <1 | <1 | <1 | <1 |
| | | | | alcohol | | |
| Formulation 2 | | lauryl | myristyl | palmityl | stearyl | arachidyl |
| | laurate | <1 | <1 | <1 | <1 | <1 |
| acid | myristate | <1 | 12-16 | 30-35 | 12-16 | <1 |
| | palmitate | <1 | 7-10 | 18-22 | 7-10 | <1 |
| | stearate | <1 | <1 | <1 | <1 | <1 |
| | | | | alcohol | | |
| Formulation 3 | | lauryl | myristyl | palmityl | stearyl | arachidyl |
| | laurate | <1 | <1 | <1 | <1 | <1 |
| acid | myristate | <1 | <1 | 18-22 | 9-11 | <1 |
| | palmitate | <1 | 0.5-1.5 | 41-45 | 20-24 | <1 |
| | stearate | <1 | <1 | <1 | <1 | <1 |
| | | | | alcohol | | |
| Formulation 4 | | lauryl | myristyl | palmityl | stearyl | arachidyl |
| | laurate | <1 | <1 | <1 | <1 | <1 |
| acid | myristate | <1 | 7-9 | 4-6 | 2-4 | <1 |
| | palmitate | <1 | 16-19 | 10-12 | 5-7 | <1 |
| | stearate | <1 | <1 | 2-4 | 40-45 | <1 |
| | | | | alcohol | | |
| Formulation 5 | | lauryl | myristyl | palmityl | stearyl | arachidyl |
| | laurate | <1 | <1 | <1 | <1 | <1 |
| | myristate | <1 | 7-9 | 4-6 | 2-4 | <1 |
| acid | palmitate | <1 | 16-19 | 10-12 | 4-6 | <1 |
| | stearate | <1 | <1 | <1 | <2 | <1 |
| | arachidate | <1 | <1 | <1 | 1-3 | <1 |
| | behenate | <1 | <1 | <1 | 40-45 | <1 |

For optimum results, esters having between 24 and 40 carbon atoms in each individual ester molecule make up at least 95% of the internal lubricant composition. Preferably these esters make up in the order of 97% of the composition. Such mixed ester compositions may be prepared by reacting a mixture of carboxylic acids with a mixture of aliphatic alcohols of the appropriate chain lengths under esterification conditions such that the individual esters of the product contain between 24 and 40 carbon atoms each. Alternatively, individual esters can be prepared having between 24 and 40 carbon atoms each and subsequently a desired number of individual esters mixed together in the desired amounts. Mixing of these esters can be achieved by weighing and intimately mixing individual esters in the appropriate wt/wt amounts in either a powder blend or a melt blend.

To achieve a desirable degree of internal lubrication in PET, the internal lubricant compositions of this invention are incorporated at levels of between 0.05% and 1% and preferably between 0.1% and 0.75% wt/wt of the total PET polymer matrix weight.

The internal lubricant composition of this invention may be incorporated into the polyester polymer matrix by a number of processes well known to those skilled in the art. For example, they may be added directly to the polymer matrix by melt dosing at the point of polymer resin extrusion, by conventional master batch addition or by incorporation using liquid colour systems.

For the avoidance of doubt, it will be appreciated that it is common practice in polymer chemistry to add a variety of additives to polymers during processing. Thus, aliphatic esters according to the present invention may not be the only additives present. It follows therefore that, to fall within the claimed scope of the present invention, two or more aliphatic esters as defined above and in the appended claims may be present in a combined amount between 0.1% and 1.0% by wt of the total polyester polymer matrix composition.

The internal lubricant compositions of the present invention can be incorporated into polymers and polymer blends using conventional techniques to form a desirable polyester polymer matrix. These include coating pellets of the polymer with the additive prior to moulding; pumping pre-melted additive into the moulding machine; mixing the additive with the PET or compatible polymer to form a concentrate containing say 10% of the additive mixture and mixing this with pellets of PET prior to moulding. The additive mixture may also be dispersed into a liquid carrier system that in turn is used to coat the polymer pellets. In any event, the most suitable dosing method will be selected by the materials specialist to suit a particular application.

The present invention will now be described with reference to the Examples provided below and the Figures, in which:

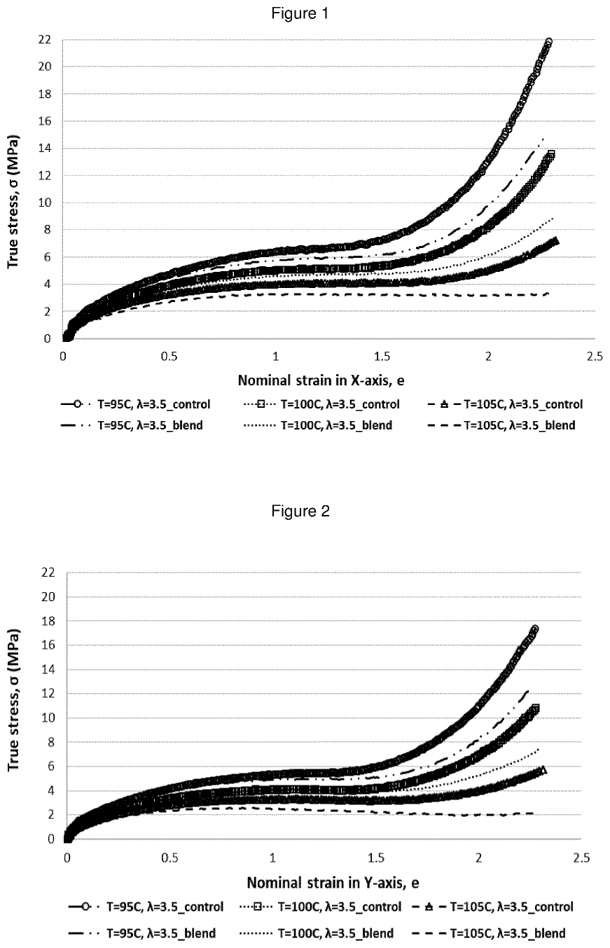

FIG. 1 shows stress-strain data at a drawing speed of 16 m/min along x-axis two days after PET preform preparation.

FIG. 2 shows stress-strain data at a drawing speed of 16 m/min along y-axis two days after PET preform preparation.

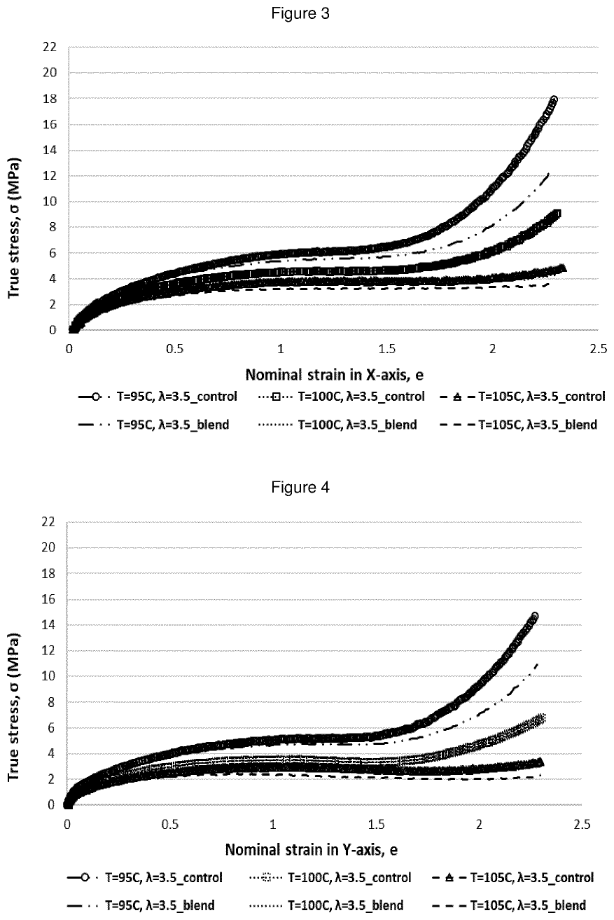

FIG. 3 shows stress-strain data at a drawing speed of 16 m/min along x-axis ten days after PET preform preparation.

FIG. 4 shows stress-strain data at a drawing speed of 16 m/min along y-axis ten days after PET preform preparation.

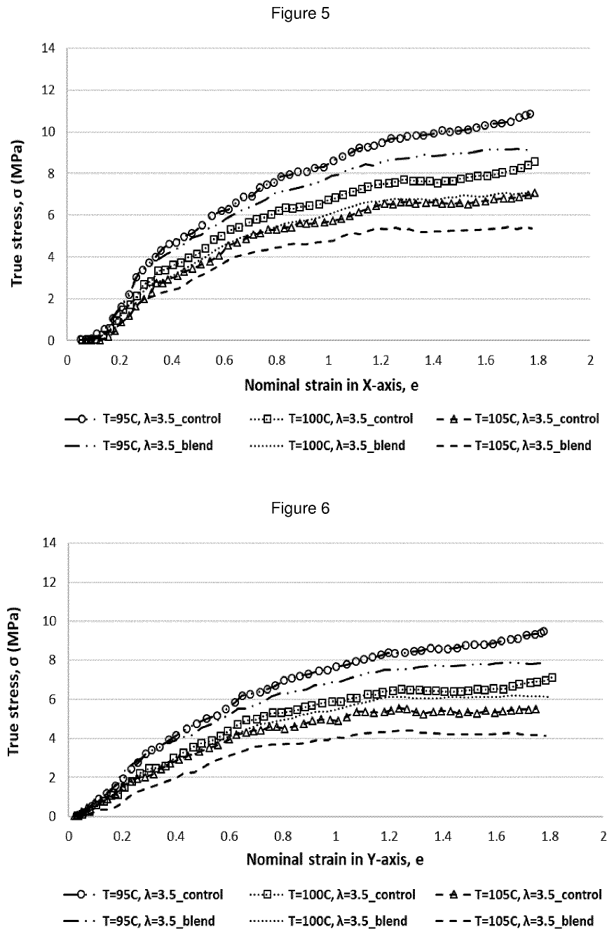

FIG. 5 shows stress-strain data at a drawing speed of 64 m/min along x-axis ten days after PET preform preparation.

FIG. 6 shows stress-strain data at a drawing speed of 64 m/min along y-axis ten days after PET preform preparation.

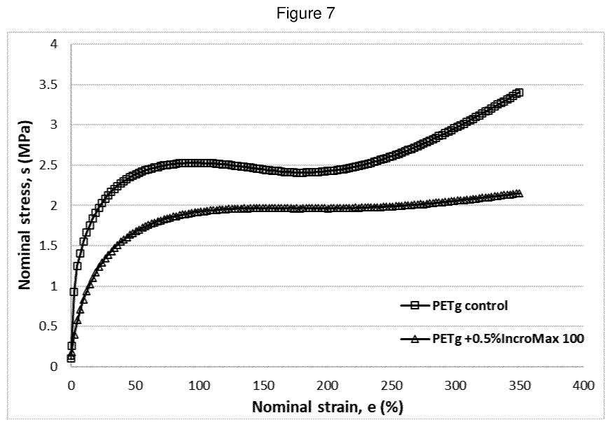

FIG. 7 shows the comparative stress-strain curve of PETg versus PETg including 0.5 wt % internal lubricant at 1 m/min 1 day after PETg preform preparation.

### EXAMPLES

### Example 1—Effectiveness in PET

To demonstrate the effectiveness of the aforementioned internal lubricant compositions in improving the internal lubricancy of a polyester matrix (PET) the following test procedure was adopted.

Control PET sample square plaque preforms of polyethylene terephthalate (PET) were formed by injection moulding using PET resin LIGHTER C93 ex. Dow. LIGHTER C93 is a PET which is commercially available for the production of containers for food, beverages, and other liquids. It is known to be suitable for use in thermoforming, injunction moulding and blow moulding techniques.

Additionally, PET plus internal lubricant sample square plaque preforms comprising PET resin LIGHTER C93 ex. Dow with the addition of 0.5 wt % of internal lubricant were also formed (identified as “blend” in the Figures). The formulation of the internal lubricant is provided in Table 1 above.

The square plaque preforms prepared were 76 mm×76 mm in length and width and 1 mm in thickness/height.

The square plaque preforms prepared were subjected to film stretching via biaxial film orientation tests in a sequential constant width mode, i.e. first stretched along the x-axis and then subsequently stretched along the y-axis. More especially, the test involves carrying out deformation of test samples at speed. The orientation can occur using different deformation modes, such as sequential or simultaneous, as well as various rates and temperatures, equivalent to an industrial process. Multiple jaws grip the square test sample along its four sides. The jaws are connected to a motor connected arm providing smooth movement in both x & y axis. The test sample and jaws are provided inside a heating chamber where uniform heating is controlled and applied. Once the test sample and air present in the chamber have reached a temperature equilibrium, then the selected deformation rate (i.e. drawing or stretch speed) is applied and the test is conducted. Information regarding suitable equipment for conducting the experiments described above can be found in:

i) McKelvey, David & Menary, G. H. & Martin, Peter & Yan, Shiyong. (2017). Thermoforming of HDPE. AIP Conference Proceedings. 1896. 060006. 10.1063/1.5008069, available on-line via https://www.researchgate.net/publication/320446584 Thermoforming of HDPE or https://aip.scitation.org/doi/abs/10.1063/1.5008069.

ii) G. H. Menary (2012), Biaxial deformation of PET in stretch blow molding. Society of Plastic Engineers, Plastic Research Online, 10.1002/spepro.003911, available on-line via, http://citeseerx.ist.psu.edu/viewdoc/download?doi=10.1.1.474.5846&rep=rep1&type=pdf.

The purpose of these tests was to assess the effect of the internal lubricant during biaxial orientation by comparing the stress-strain behaviour between control PET and PET plus internal lubricant samples in accordance with the present invention.

The biaxial film orientation test variables are shown in Table 1, below:

TABLE 1

| Condition Variables | | | |
|---|---|---|---|
| Temperature (° C.) | 95 | 100 | 105 |
| Strain rate (s⁻¹) | 4 | 16 | |
| Drawing speed (m/min) | 16 | 64 | |
| Stretch ratio (λ) | 2.5 | 3 | 3.5 |

The biaxial film orientation tests were conducted as two sets of tests, time spaced: the first set of tests were performed two days after the initial preparation by injection moulding of the square plaque preforms, and the second set of tests were performed ten days after the initial preparation by injection moulding of square plaque preforms.

The test condition variables detailed above were chosen because they are within the normal processing range used in industry for injection stretch blow moulding of PET bottles and thermoforming for packaging applications, as well as in biaxial orientation of PET film. As such, the tests give a good indication of the utility of the present invention across these application areas.

Test Results

The stretching behaviour of the films formed from the square plaque preforms detailed above are shown in the FIGS. 1 to 6 provided herewith and are discussed below. The reduction of stretching load observed in the “blend” samples (as they are identified in the Figures) containing internal lubricant compared to the control PET samples can be attributed to the internal lubricating effect of the internal lubricant addition; all other aspects of the polymer matrix are the same.

FIG. 1 shows the stretching behaviour of films stretched two days after preform preparation. The stress-strain graph depicts a strain rate of 4/s along the X-axis, corresponding to a drawing speed of 16 m/min, and shows that the addition of 0.5 wt % internal lubricant reduces the required load at all three drawing temperatures tested. FIG. 2 shows stretching behaviour of the same samples subsequently drawn at a speed of 16 m/min along the Y-axis, again the reduction of required loading in the presence of the internal lubricant is demonstrated.

FIG. 3 shows the stretching behaviour of films stretched ten days after preform preparation. The stress-strain graph depicts a strain rate of 4/s along the X-axis, corresponding to a drawing speed of 16 m/min, and shows that the addition of 0.5 wt % internal lubricant reduces the required load in all three drawing temperatures, but especially at 95° C. and 100° C. The same behaviour described above in FIG. 3 is also observed in Y-axis direction stretching, as shown in FIG. 4; FIG. 4 shows the stretching behaviour of the same samples subsequently drawn at a speed of 16 m/min along the Y-axis.

Advantageously, the PET with internal lubricant could be drawn at lower temperatures as compared to blank PET, as demonstrated by the assistance to polymer matrix flow provided by the presence of the internal lubricant at this relatively low test temperature of 95° C.

FIG. 5 shows the stretching behaviour of films stretched ten days after preform preparation. The stress-strain graph depicts a strain rate of 16/s along the X-axis, corresponding to a drawing speed of 64 m/min, and shows that the addition of 0.5 wt % internal lubricant reduces the required load in all three drawing temperatures. FIG. 6 shows the stretching behaviour of the samples subsequently drawn at a speed of 64 m/min along the Y-axis. Again, the reduction in required load is observed as per in FIG. 5. As such, an improvement along both the y and x-axis are observed when the preform has rested for 10 days prior to stretching. This demonstrates that there may be an additional advantage to employing the internal lubricants of the present invention in those processes where longer periods between preform preparation and final product processing occurs.

The time period between the preform preparation (moulding) and the solid-phase orientation stage (film stretching in the Examples herewith) influences the overall stretching behaviour of the material. The required stretching load is lower when the time period between the preform and the solid-phase orientation stage is longer. This effect is observed with PET control samples, but the effect is greater for samples where the internal lubricant is present. As such, there seems to be a synergy or improvement realised by virtue of “resting” the preforms.

The reduction of stretching load when the internal lubricant is used means that drawing of such materials requires less energy when compared to control PET. It also allows such a material to be be drawn further (compared to control PET), since there is provision of load tolerance for additional stretching within the polymer matrix.

### Example 2—Effectiveness in PETg

To demonstrate the effectiveness of the aforementioned internal lubricant compositions in improving the internal lubricancy of an alternative polyester matrix (PETg) the following test procedure was adopted.

Control PETg sample square plaque preforms of polyethylene terephthalate glycol (PETg) were formed by injection moulding using PETg resin Eastar GN001 ex. Eastman. Eastar GN001 is a PETg which is commercially available for the production of containers for cosmetics, food, beverages, and other liquids.

Additionally, PETg plus internal lubricant sample square plaque preforms comprising PETg resin Eastar GN001 ex. Eastman with the addition of 0.5 wt % of internal lubricant were also formed. The formulation of the internal lubricant is provided in Table 1 above.

The square plaque preforms prepared were 90 mm×90 mm in length and width and 1.2 mm in thickness/height. The preforms were prepared via injection moulding. After the plaque samples were produced, they were rested at room temperature for 24 hours and were then subjected to free tensile drawing at an elevated temperature of 90° C., i.e. above the PETg's glass transition temperature (T_{g}). The tensile machine used was a Testometric M350-10CT fitted with a heating chamber. The heating chamber was preheated to the desired temperature. Each plaque sample was clamped, to provide a 40 mm gauge length, and the sample was subject to heating for 6 minutes. The maximum elongation was set at 140 mm which corresponds to a draw ratio of 3.5 (using the gauge length of 40 mm). The maximum drawing speed of the tensile machine was used, which in this case was 1 m/min. The complete tensile drawing test conditions are shown in Table 4 below.

TABLE 4

| Parameter | Value |
|---|---|
| Temperature (° C.) | 90 |
| Haul-off speed (mm/min) | 1000 |
| Elongation (mm) | 140 |
| Draw ratio, λ | 3.5 |
| Soaking time (min) | 6 |

A total of 6 sample plaques were tested for the control PETg and 5 sample plaques were tested for the PETg plus 0.5% internal lubricant. All the (engineering) stress-strain graphs were collected and the average curve from each material tested was calculated.

Test Results

The comparison between the average stress-strain curve of the control PETg versus the PETg plus 0.5% internal lubricant is shown in FIG. 7 and it is clear that the use of the internal lubricant in the PETg reduces the drawing stress. Here, each curve shown relates to the average of the total samples tested for each respective material. The advantage of the effect on the PETg due to the internal lubricant is the ability to stretch the material containing the internal lubricant at a lower temperature, or to stretch it more at the same temperature.

The advantages of the internal lubricant compositions of the present invention can be readily appreciated by reference to the above results.

1. An internal lubricant composition suitable for use in a polyester polymer matrix composition comprising a mixture of two or more esters in which each individual ester has a carbon chain length of between 20 and 44.

2. An internal lubricant composition according to claim 1 comprising a mixture of two or more esters in which each individual ester has a carbon chain length between 28 and 34.

3. An internal lubricant composition according to claim 1 comprising two or more esters selected from the group comprising myrisityl myristate, myrisityl palmitate, palmityl myristate, palmityl palmitate, palmityl stearate, stearyl myristate, stearyl palmitate, stearyl stearate, stearyl arachidate and stearyl behenate.

4. An internal lubricant composition according to claim 1 comprising two or more esters selected from the group comprising myristyl myristate, myristyl palmitate, palmityl myristate, palmityl palmitate, stearyl myristate and stearyl palmitate.

5. An internal lubricant composition according to claim 3, wherein the composition comprises between four and ten esters selected from said group.

6. An internal lubricant composition according to claim 1, wherein each individual ester component may be present in an amount of 0.5% to 95% by weight (wt) of the total internal lubricant composition

7. An internal lubricant composition according to claim 1, wherein each individual ester component may be present in an amount of 0.5% to 45% by weight (wt) of the total internal lubricant composition.

8. An internal lubricant composition according to claim 1, wherein said composition comprises <1% to 17% myristyl myristate, 0.5% to 38% myristyl palmitate, 4% to 45% palmityl myristate, 4% to 45% palmityl palmitate, 2% to 20% stearyl myristate, 4% to 45% stearyl palmitate, <1% to 4% palmityl stearate, <1% to 4% stearyl stearate, <1% to 3% stearyl arachidate, and <1% to 4% stearyl behenate, by weight.

9. An internal lubricant composition according to claim 1, wherein said composition comprises 10% to 17% myristyl myristate, 2% to 28% myristyl palmitate, 15% to 42% palmityl myristate, 8% to 42% palmityl palmitate, 4% to 18% stearyl myristate and 6% to 12% stearyl palmitate, by weight.

10. A polyester polymer matrix comprising a polyester polymer and an internal lubricant composition in accordance with claim 1.

11. A polyester polymer matrix according to claim 10, where in the polyester polymer is selected from the group comprising poly(butylene terephthalate), poly(cyclohexanedimethylene terephthalate), poly(ethylene isophthalate), poly(ethylene 2,6-naphthalenedicarboxylate), poly(ethylene phthalate), poly(ethylene terephthalate), PETg (polyethylene terephthalate glycol), polycarbonates, polylactic acid (PLA), polyhydroxyalkanoates (PHA), and co-polymers thereof.

12. A polyester polymer matrix according to claim 10, wherein the polyester polymer comprises poly(ethylene terephthalate) or polylactic acid (PLA).

13. A polyester polymer matrix according to claim 10, wherein the polymer matrix composition comprises said internal lubricant composition in an amount of between 0.05 wt % to 1.0 wt %.

14. A polyester polymer matrix according to claim 13, wherein the polymer matrix composition comprises said internal lubricant composition in an amount of between 0.1 wt % to 0.75 wt %.

15. A polyester polymer matrix according to claim 10, further comprising one or more additional polymer additives.

16. A method for processing a polyester polymer matrix to produce a final polyester product comprising contacting the polymer matrix with an internal lubricant composition according to claim 1.

17. The method in accordance with claim 16, wherein processing of the polyester polymer matrix is carried out at a lower process temperature and/or pressure and/or mechanical stress, than would be possible in the absence of said internal lubricant.

18. The method in accordance with claim 16, wherein the process is any of thermoforming, injection moulding, extrusion, cast film extrusion, extrusion blow moulding, injection stretch blow moulding, stretch blow moulding and biaxial film orientation.

19. The method in accordance with claim 16, wherein the final polyester product is in the form of a container or film.

20. The method in accordance with claim 19, wherein the final polyester product is a bottle.

21. A method of internally lubricating a polyester polymer matrix by incorporating an internal lubricant composition according to claim 1.

22. A method of internally lubricating a polyester polymer matrix in accordance with claim 21, wherein incorporation of the internal lubricant is achieved be adding directly to the polymer matrix by melt dosing at the point of polymer resin extrusion, by conventional master batch addition or by incorporation using liquid colour systems.
